(19) United States
(12) Patent Application Publication
(10) Pub. No.: US 2013/0014508 A1
(43) Pub. Date: Jan. 17, 2013

(54) Optimized Heliostat Aiming

(71) Applicant: Alec Brooks, Pasadena (CA)

(72) Inventor: Alec Brooks, Pasadena (CA)

(73) Assignee: GOOGLE INC., Mountain View, CA (US)

(21) Appl. No.: 13/182,888

(22) Filed: Jul. 14, 2011

(51) Int. Cl. F03G 6/04; F24J 2/40; F03G 6/06; F24J 2/38

(52) U.S. Cl. 60/641.14; 126/600; 126/585; 126/593; 126/602; 60/641.11

(57) ABSTRACT

Methods and systems for aiming heliostats toward a receiver. One of the methods includes directing a first subset of a set of heliostats to reflect solar rays toward a first location within an aperture of a receiver and directing a second subset of the set of heliostats to reflect solar rays toward one or more second locations within the aperture of the receiver. The solar rays reflected toward the first location provide solar heat to at least a first flow path of a working fluid in an engine assembly coupled to the receiver. The solar rays reflected toward the one or more second locations provide solar heat to a second flow path of the working fluid. The first and second flow paths correspond to heating at first and second stages respectively within the engine assembly, which is configured to generate power from the solar rays reflected to the receiver.

### TECHNICAL FIELD

This specification relates to heliostat aiming toward receivers.

### BACKGROUND

Heliostats can be used to collect radiation from the Sun. Specifically, a heliostat can include one or more mirrors to direct solar rays toward a receiver mounted on a receiver tower. Some types of heliostats are capable of moving their mirror or mirrors as the Sun moves across the sky, both throughout the day and over the course of the year, in order to direct solar rays to the receiver. Solar rays that are directed to the receiver can then be used to generate solar power. A field of heliostats can be placed surrounding one or more receivers to increase the quantity of radiation collected and maximize the amount of solar power that is generated.

The solar energy can be converted to electricity by the receiver or a generator that is coupled to the receiver. Typically, a working fluid that circulates within a receiver is heated by solar energy incident on the receiver. The heated working fluid can then be used to power a turbine and generator to produce electricity.

### SUMMARY

In general, in one aspect, the subject matter described in this specification can be embodied in methods for aiming heliostats toward a receiver, which include directing a first subset of a set of heliostats to reflect solar rays toward a first location within an aperture of a receiver and directing a second subset of the set of heliostats to reflect solar rays toward one or more second locations within the aperture of the receiver. The solar rays reflected toward the first location provide solar heat to at least a first flow path of a working fluid in an engine assembly coupled to the receiver. The solar rays reflected toward the one or more second locations provide solar heat to a second flow path of the working fluid. The first flow path and the second flow path correspond to heating at a first stage and a second stage respectively within the engine assembly that is coupled to the receiver. The engine assembly is configured to generate power from the solar rays reflected to the receiver.

These and other embodiments can each optionally include one or more of the following features, alone or in combination. The heliostats that are included in at least one of the first subset or the second subset can be selectively changed to adjust a level of heat provided to at least one of the first flow path or the second flow path. Temperature of the working fluid can be measured at one or more locations in the engine assembly and selectively changing the heliostats can be based at least in part on the measured temperatures. The solar intensity incident on the receiver can be determined and selectively changing the heliostats can be based at least in part on the determined solar intensity. At a given time on a given day, selectively changing the heliostats can be based at least in part on expected intensity and/or location of the Sun at the given time on the given day.

The first location within the aperture can be substantially coincident with a center of the aperture, and the one or more second locations can be located one or more predetermined distances away from the center. The first subset of heliostats can be located further away from the receiver than the second subset of heliostats.

The engine assembly can include at least a first turbine and a second turbine and the working fluid can be air. Air in the engine can be directed through the first flow path for heating prior to entering the first turbine and air exiting the first turbine can be directed through the second flow path for re-heating prior to entering the second turbine. At least one of the first turbine or the second turbine can provide mechanical energy to a generator that is configured to produce electricity. The engine can be a multi-stage compression Brayton-cycle engine, a Rankine cycle engine or otherwise. Solar rays reflected toward the first location can also provide solar heat to the working fluid in the second flow path.

In general, in another aspect, a system is described that includes a receiver tower, a first subset of heliostats, a second subset of heliostats and an engine. The receiver tower is positioned in proximity to multiple heliostats and includes a receiver mounted on the receiver tower configured to receive solar rays directed to the receiver from the heliostats. The first subset of heliostats is directed to reflect solar rays to a first location within an aperture of the receiver. The second subset of heliostats is directed to reflect solar rays to one or more second locations within an aperture of the receiver. The engine is coupled to the receiver. A working fluid in the engine is directed through a first flow path that receives solar heat from the solar rays directed to the first location and the working fluid is directed through a second flow path that receives solar heat from at least the solar rays directed to the one or more second locations.

These and other embodiments can each optionally include one or more of the following features, alone or in combination. The engine can include at least a first turbine and a second turbine. The working fluid can be air that is directed through the first flow path for heating prior to entering the first turbine and directed through the second flow path for re-heating after exiting the first turbine and prior to entering the second turbine. The system can further include at least one generator coupled to at least one of the first turbine or the second turbine. The generator can be configured to receive mechanical energy from the at least one turbine and to generate electricity. The receiver can include a cavity formed behind the aperture, such that solar rays directed to the first location within the aperture are incident on a first portion of a surface area of the cavity and solar rays directed to the one or more second locations within the aperture are incident on a second portion of the surface area of the cavity. The first flow path can receive solar heat from the solar rays incident on the first portion of the surface area and the second flow path can receive solar heat from the solar rays incident on the second portion of the surface area.

The system can further include a controller configured to selectively change which heliostats are included in at least one of the first subset or the second subset to adjust a level of heat provided to the working fluid directed through at least one of the first flow path or the second flow path. The controller can be further configured to receive temperature information from one or more sensors measuring temperature of the working fluid within the engine and to selectively change the heliostats based on the temperature information. For a given day, the controller can be further configured to selectively change the heliostats based on expected intensity and location of the Sun at different times throughout the given day. For a given day, the controller can be further configured to receiver solar intensity information from one or more sensors measuring solar intensity at one or more locations within the receiver and to selectively change the heliostats based on the solar intensity information.

In general, in another aspect, a system is described that includes a receiver tower, heliostats and an engine. The receiver tower is positioned in proximity to multiple heliostats and includes a receiver mounted on the receiver tower configured to receive solar rays directed to the receiver from the heliostats. The receiver includes a cavity having a surface area that is formed behind the aperture. A first subset of heliostats is directed to reflect solar rays to a first location within an aperture of the receiver, which solar rays are incident on a first portion of the surface area of the cavity. A second subset of heliostats is directed to reflect solar rays to a second location within the aperture of the receiver, which solar rays are incident on a second portion of the surface area of the cavity. The engine is coupled to the receiver. A working fluid of the engine is heated at a first stage by solar heat from the first portion of the surface area of the cavity and is re-heated at a second stage by solar heat from the second portion of the surface area of the cavity.

These and other embodiments can each optionally include one or more of the following features, alone or in combination. The working fluid can pass through a first flow path that receives the solar heat from the first portion of the surface area of the cavity and pass through a second flow path that receives the solar heat from the second portion of the surface area of the cavity. The first flow path can be a path through a first tubing that is positioned behind or in front of the first portion of the surface area of the cavity and the second flow path can be a path through a second tubing that is positioned behind or in front of the second portion of the surface area of the cavity. The first flow path can be a path through a first tubing that has an external surface that comprises the first portion of the surface area of the cavity and the second flow path can be a path through a second tubing that has an external surface that comprises the second portion of the surface area of the cavity.

The engine can further include a first heat exchanger configured to transfer heat from a first working fluid to the working fluid of the engine to provide heat at the first stage and a second heat exchanger configured to transfer heat from a second working fluid to the working fluid of the engine to provide heat at the second stage. The first working fluid can be directed through a first flow path that receives solar heat from the first portion of the surface area and the second working fluid can be directed through a second flow path that receives solar heat from the second portion of the surface area. The system can further include a controller configured to selectively change which heliostats are included in at least one of the first subset or the second subset to adjust a level of heat provided to the working fluid at the first stage or the second stage.

Particular embodiments of the subject matter described in this specification can be implemented so as to realize one or more of the following advantages. The solar heat incident on particular portions of the surface area of a cavity of a receiver that is adapted to receive solar rays reflected from heliostats can be selectively controlled. For example, to avoid damaging the surface area of the cavity due to uneven distribution of solar flux across the surface, certain heliostats can be directed to aim toward different locations within the receiver aperture, so as to control where the solar rays from these heliostats are incident on the surface area. Potentially damaging hot spots can thereby be avoided. Tubing that runs behind the cavity surface, or that forms the cavity surface, that has a fluid within that is heated by the solar heat incident on the cavity surface can be configured to provide two or more flow paths. The amount of solar heat provided to each of the two or more flow paths can be different among the flow paths and can be adjusted independently. For example, if the two or more flow paths carry a working fluid for an engine, which working fluid is being heated (e.g., in a first flow path) and re-heated (e.g., in a second flow path), the amount of heat provided at the two heating stages can be varied and controlled independently.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic representation of a solar energy system including an example solar energy receiver in a field of heliostats.

FIG. 2 shows a schematic representation of the front face of the example solar energy receiver shown in FIG. 1

FIG. 3A is a schematic representation of a cross-sectional view of a receiver cavity.

FIG. 3B is a schematic representation of an example engine that receives solar heat for a working fluid.

FIG. 4 is a flowchart showing an example process for assigning heliostats to direct solar rays to particular locations.

Like reference numbers and designations in the various drawings indicate like elements.

### DETAILED DESCRIPTION

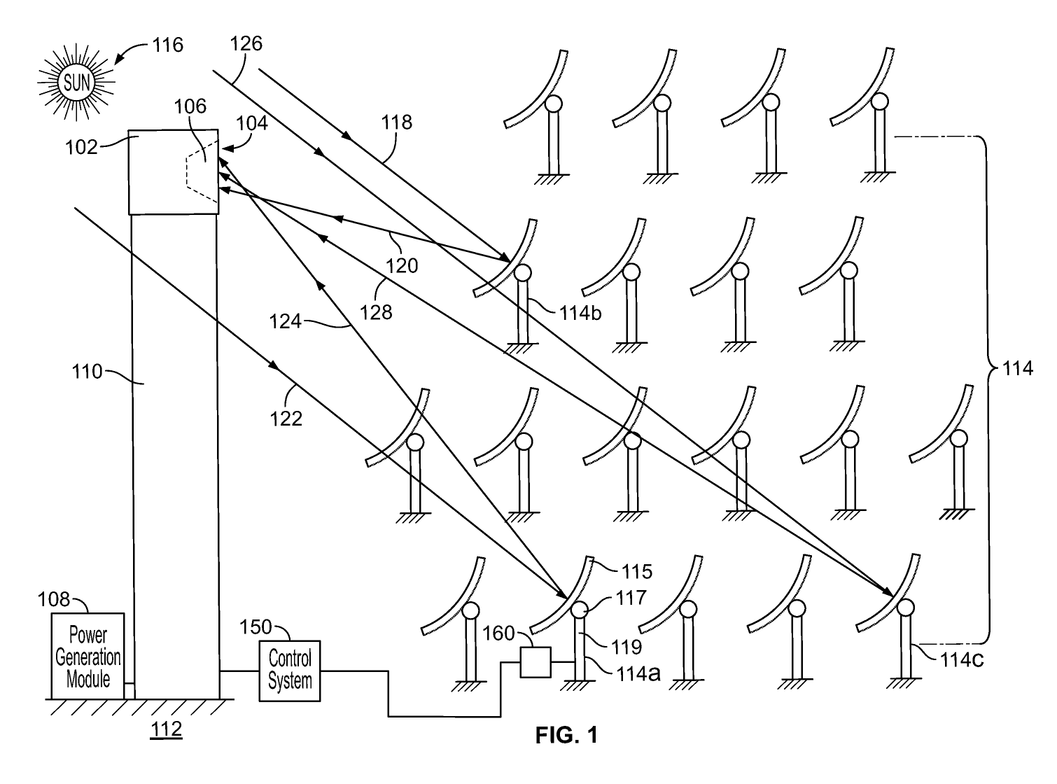

FIG. 1 is a schematic representation of a solar energy system including an example solar energy receiver 102 in a field of heliostats 114. The receiver 102 is mounted on a receiver tower 110 which is secured to a terrestrial surface 112, and is configured to receive solar rays reflected by the heliostats 114. The heliostats 114 are able to vary the direction in which their one or more reflective surfaces are pointing and can be pitched and angled so as to reflect incoming sunlight toward an aperture 104 of the receiver 102. Arrows 120, 124 and 128 are simplified schematic representations of some of the reflected sunlight. The orientation of the reflective surfaces of the heliostats can be varied throughout the day, for example, to track the Sun as it appears to move across the daytime sky in order to maintain their reflective relationship with the receiver 102.

A control system can be configured to control the positioning of one or more reflective surfaces included on each of the heliostats 114, e.g., based on positions of the heliostats relative to the Sun 116. In some implementations, the control system may provide signals to a drive system to substantially control the pitch and angle of the heliostat mirrors to control the direction in which solar rays incident on their reflective surfaces is reflected. In some implementations, the control system is implemented as a controller at each of the individual heliostats 114. That is, the heliostats 114 may include processors that substantially independently determine and control the pitch and angle of the heliostats' reflective surfaces. In other implementations, the control system can be implemented remote from the heliostats and provide signals to the drive system, e.g., over a wired or wireless communication network or otherwise.

The heliostats 114 shown in FIG. 1 are simplified schematic representations. Each heliostat can be formed in any convenient manner. Generally, each heliostat includes one or more reflective surfaces (e.g., 115), a support member (e.g., 119) to elevate the reflective surface off the ground and a drive system (e.g., 117) to change the orientation of the reflective surface. In some implementations, the reflective surface can be mirrored and can be curved or flat and can be formed as a unitary surface or two or more surfaces operating cooperatively. Other configurations of reflective surface can be used. The support member can be a pole, frame or other support structure that is configured to position the reflective surface to receive solar rays from the Sun and reflect them toward a target location, e.g., a receiver aperture. The support member can be a unitary member or formed from two or more members together. The drive system can be one drive mechanism or can be two or more drive systems, e.g., a first drive system to change the elevation of the reflective surface and a second drive system to change the azimuth of the reflective surface. The drive system can use various mechanisms to change the orientation of the reflective surface, e.g., one or more motors. The heliostats can be configured in different ways, have different drive systems and different types of reflective surfaces. The simplified heliostat shown is for illustrative purposes and does not limit the configuration of heliostats that can be used in the methods and systems described herein.

Although several heliostats 114 are shown in proximity to the receiver 102, there may be more or fewer heliostats and those shown are for illustrative purposes. The receiver 102 includes the aperture 104 that is configured to receive solar rays that are reflected from the heliostats 114. A cavity 106 can be formed behind the aperture 104. The cavity 106 can have cavity walls made of a heat conductive material, behind or in front of which is positioned tubing through which a working fluid flows. In other implementations, the tubing itself can be arranged to form the walls of the cavity. The heat from the solar rays received in the cavity 106 and incident on the surface area of the cavity is used to heat the working fluid. Some examples of working fluid include air, water and molten salt, although other fluids can be used. The heated working fluid can be used to power an engine and drive a generator to produce electricity, i.e., using the power generation module 108. For example, a liquid working fluid can produce steam to power a turbine that is coupled to a generator. In other examples, the heat is used to heat air or another gas that is expanded through a turbine, which turns a shaft to drive a generator. The electricity can be conducted to a utility grid, or some other point where the electricity can be stored, distributed or consumed. In the implementation shown, the power generation module 108 is positioned next to the receiver 102. However, it should be understood that in other implementations, the power generation module 108 can be integrated into the receiver 102 (e.g., positioned at or near the top of the tower), or can be located remote from the receiver 102 and coupled by tubing, for example, to transport a working fluid to and from the power generation module 108 from the receiver 102. Other arrangements are possible.

An engine that is coupled to the receiver may require heating of the working fluid at more than one stage in the engine cycle. Additionally, the heat requirements at two or more stages in the engine cycle may be different and may vary over time. As such, two or more flow paths of working fluid can be provided through tubing that receives solar heat from the receiver 102. A first flow path receives solar heat from solar rays that are incident on a first portion of a surface area of the cavity 106. A second flow path receives solar heat from solar rays that are incident on a second portion of a surface area of the cavity 106. In addition to being able to control the heat provided at the two or more stages in the engine cycle, the operating point of the engine can be controlled. For example, there are temperature limits for components of an engine and being able to control the operating point facilitates avoiding temperatures that exceed the limits. Efficiency of the engine can also be improved (i.e., the power output) by controlling the operating point.

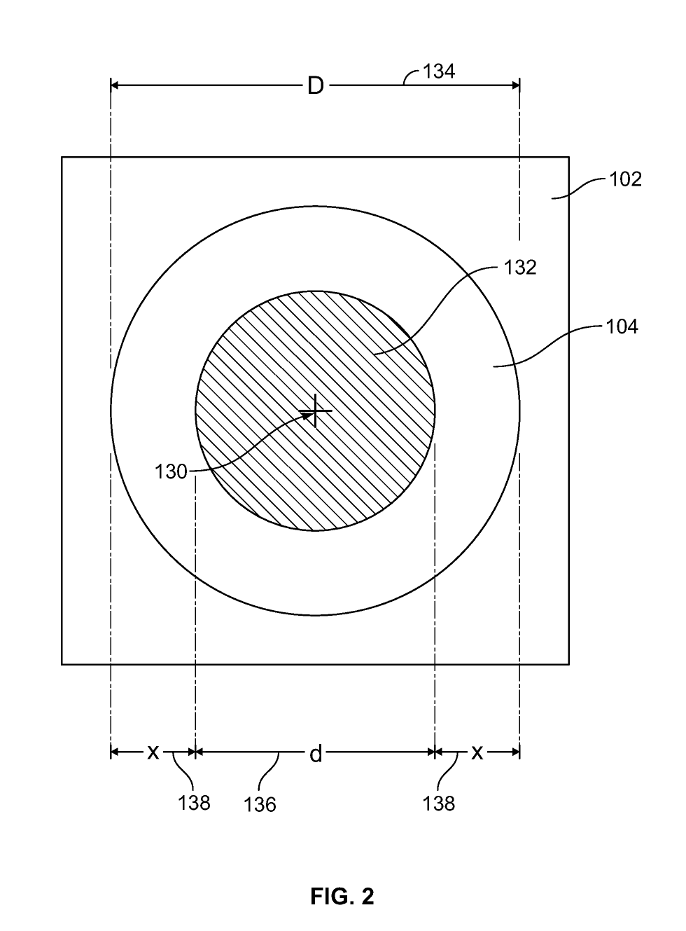

FIG. 2 shows a schematic representation of the front face of the example solar energy receiver 102 shown in FIG. 1. In the example receiver 102 shown, the aperture 104 has a circular shape, however, in other implementations the aperture can be configured differently. The shaded area represents an image 132 of sunlight projected from a heliostat onto the receiver 102, that is, the solar ray reflected from the heliostat project the image of sunlight 132 onto the receiver. More particularly, the image 132 of sunlight is incident on a portion of the surface area of the cavity 106 that is formed behind the aperture 104. The diameter of the image is d (represented by dimension arrow 136) and the diameter of the aperture 104 is D (represented by the dimension arrow 134). The difference in diameters is 2x, as represented by dimension arrows 138. The closer a heliostat is to the receiver 102, the smaller the image of sunlight projected on the receiver 102. That is, a closer heliostat such as heliostat 114b projects a smaller dimension image of sunlight on the receiver than a further away heliostat, such as heliostat 114c. In the example shown, the image 132 appears circular, however, it should be understood that the image may have a different shape, e.g., depending on the shape of the reflective surface of the heliostat and the relative locations of the heliostat, Sun and receiver.

To avoid having the image of sunlight from the further away heliostats spillover from the intended target, i.e., from the aperture 104, the aperture 104 and the heliostat mirrors can be dimensioned so that the image of sunlight projected by the furthest away heliostats falls approximately within the bounds of the aperture 104. However, this also means that the image of sunlight from the closer heliostats is well within the bounds of the aperture 104, for example, the image 132 shown in FIG. 2. This allows some flexibility in positioning the image of sunlight from at least some of the heliostats relative to the aperture 104. For example, as shown, the image of sunlight 132 is centered within the aperture 104. That is, the approximate center of the image 132 is coincident with the center 130 of the aperture. However, the image of sunlight 132 could be centered up to the distance x higher, lower, to the left or to the right and still fall within the bounds of the aperture 104. By having a heliostat direct the heliostat's image of sunlight toward a particular location within the aperture 104, the intensity of the solar rays incident on particular portions of the surface area of the cavity 106 formed behind the aperture 104 can be selectively controlled. The intensity of solar heat that is provided to heat a working fluid passing through a flow path that is heated by a particular portion of the surface area of the cavity 106 can thereby also be selectively controlled.

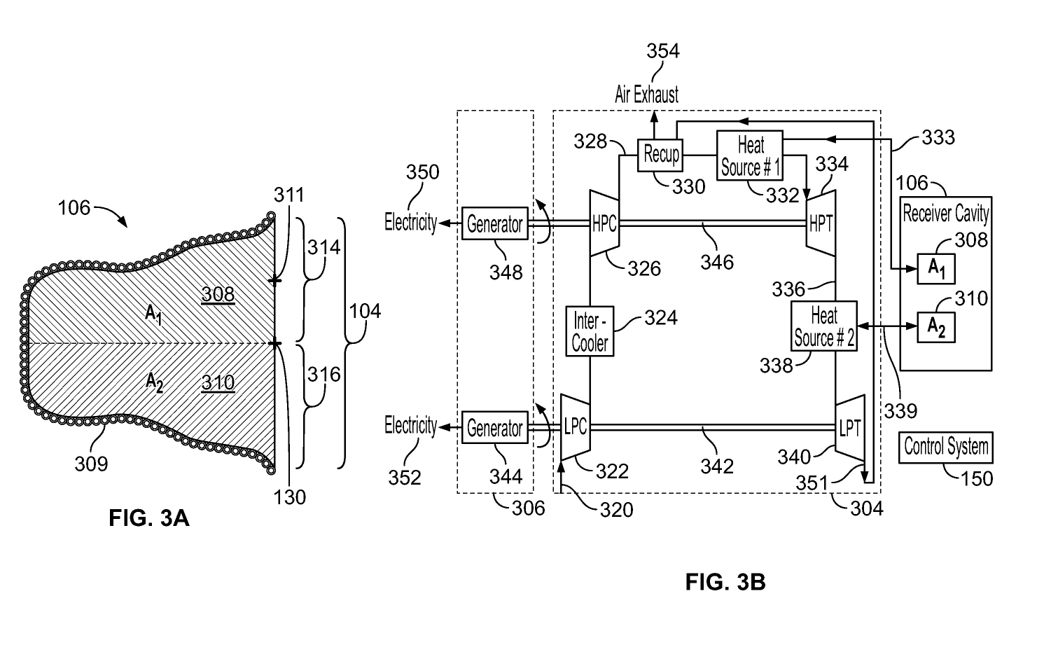

FIG. 3A is a schematic representation of a cross-sectional view of a receiver cavity, e.g., the cavity 106 formed behind the aperture 104 of the receiver 102 shown in FIG. 1. The cavity 106 of the receiver is shown in a cross-sectional side view. In the implementation shown, tubing that is configured to transport a working fluid (or fluids) for an engine is positioned behind the surface area of the cavity, i.e., tubes 309 (although in other implementations the tubing can be in front of the surface area or form the surface area). As is described further below, the tubing can be configured to form two or more separate flow paths. In this implementation, a first flow path of tubing receives solar heat from solar energy incident on an upper portion A₁ 308 of the surface area of the cavity and a second flow path of tubing receives solar heat from solar energy incident on a lower potion A₂ 310 of the surface area of the cavity.

The opening of the cavity, i.e., the aperture 104 has an approximate center point 130. Of the multiple heliostats that are directed to reflect solar rays toward the aperture 104, such that they are incident on the surface area of the cavity 106, some can be set to direct their respective image of sunlight toward the center of the aperture, whereas others can be set to direct their respective images of sunlight at a different location within the aperture so as to be incident on a different portion of the cavity's surface area. It should be understood that the receiver can be configured differently than shown. For example, the aperture and the cavity may be oriented other than horizontally as shown and may or may not be co-axial with each other. In one example, the aperture and cavity can point downwardly at an angle or straight down.

Certain heliostats in a set of heliostats (i.e., the heliostats 114) that are directed to reflect solar rays toward the aperture 104, can be positioned so that the approximate center of the image of sunlight they project on the surface area of the cavity 106 is above, below, to the left or to the right of the center 130 of the aperture. For example, certain heliostats, such as heliostat 114a, can adjust the orientation of their respective reflective surfaces, so that the image of sunlight they project is substantially directed to the upper half of the aperture, i.e., directed toward region 314 and approximately centered at location 311. Certain other heliostats, such as heliostat 114b, can adjust the orientation of their respective reflective surfaces so that the image of sunlight they project is substantially directed to the lower half of the aperture, i.e., toward region 316. Other of the heliostats, i.e., those positioned further away from the receiver, such as heliostat 114c, can adjust the orientation of their respective reflective surfaces so that the image of sunlight they project is approximately centered at the center of the aperture 104, i.e., at center location 130.

FIG. 3B is a schematic representation of an example engine 304 that receives solar heat for a working fluid. In the example shown, the engine 304 is a two-compression phase Brayton-cycle engine and the working fluid is a gas, e.g., air. The engine 304 is coupled to a generator module 306, which in this example includes two generators 344, 348 that receive mechanical energy from the engine 304 and generate electricity 350, 352. The engine 304 and generator module 306 together are an example of the power generation module 108 shown in FIG. 1, although it should be understood that differently configured engines and power generation modules can be used. In another example implementation, the engine can be a Rankine cycle engine with multiple re-heat stages. Other engine configurations are possible.

Referring again to FIG. 1 and FIG. 3A, schematic representations of solar rays from the Sun incident on the reflective surfaces of the heliostats 114a-c are shown. An example solar ray 118 is incident on the reflective surface of the heliostat 114b, which has its reflective surface oriented so that the reflected solar ray 120 is directed toward the lower region of the receiver aperture, i.e., region 316 of the aperture 104. Solar rays directed toward the lower region of the receiver aperture can be incident on the lower portion of the surface area of the cavity, that is, the portion A₂ 310. That is, the image of sunlight projected by the heliostat 114b on the surface area of the cavity can fall (at least primarily) within the portion A₂ in this example.

As shown in FIG. 1, another example solar ray 122 is incident on the reflective surface of the heliostat 114a, which has its reflective surface oriented so that the reflected solar ray 124 is directed toward the upper region of the receiver aperture, i.e., region 314. As shown in FIG. 3A, solar rays directed toward the upper region of the aperture can be incident on the upper portion of the surface area of the cavity, that is, the portion A₁ 308. An image of sunlight projected by the heliostat 114a on the surface area of the cavity therefore falls within the portion A₁ in this example.

As shown in FIG. 1, another example solar ray 126 is incident on the reflective surface of the heliostat 114c, which has its reflective surface oriented so that the reflected solar ray 128 is directed toward the center of the receiver aperture, i.e., directed to location 130. An image of sunlight projected by the heliostat 114c on the surface area of the cavity will be larger in dimensions than the images of sunlight projected by the heliostats 114a and 114b because the heliostat 114c is further away from the receiver 102. The image of sunlight projected by the heliostat 114c when the heliostat is directed to reflect solar rays toward the center 130 of the aperture 104 will be incident, at least in part, on both the upper portion A₁ 308 and the lower portion A₂ 310 of the surface area of the cavity.

The above examples illustrate that some heliostats can be directed to reflect solar rays so as to be incident on mutually exclusive portions of the surface area of the cavity, e.g., heliostats 114a and 114b direct rays to be incident on portions A₁ and A₂ respectively. However, some heliostats can be directed to reflect solar rays so as to be incident on overlapping portions of the surface area of the cavity. That is, for example, heliostat 114c directs rays to be incident on at least some of both portions A₁ and A₂, which overlaps with the portions receiving solar rays from the heliostats 114a and 114b respectively. It should also be understood, that even though the heliostat 114a is directed to reflect solar rays toward the upper region of the aperture, depending on the dimensions of the image of sunlight projected by the heliostat 114a on the surface area of the cavity, the image may be incident primarily on the upper portion A₁ but also be incident (at least in part) on the lower portion A₂. As such, the surface area of the cavity receiving solar rays from the heliostats 114a and 114b may overlap to some degree.

FIG. 3B shows a block diagram of an illustrative example of a multi-stage engine 304 that drives a generator module 306 that includes two generators. In the illustrated example, a first generator 348 is coupled to a high pressure stage of the engine 304. The high pressure stage includes a high pressure compressor 326 and a high pressure turbine 334 coupled to each other and to the generator 348 by a rotatable shaft 346. A second generator 344 is coupled to a low pressure stage. By way of example, in some implementations, the output pressure of the high pressure stage can be about 2.5 to 5 times the output pressure of the low pressure stage. The low pressure stage includes a low pressure compressor 322 and a low pressure turbine 340 coupled to each other and to the generator 344 by a rotatable shaft 342. In some implementations, the low pressure stage and the high pressure stage may each be configured as Brayton cycle engines as shown. While the present example is illustrated and described as having two stages, in some implementations any practical number of stages may be used.

In the illustrated example, ambient or otherwise substantially unpressurized air 320 is drawn into the low pressure compressor 322 through an air inlet. That is, in this example, the working fluid for the engine is air. The air pressure is increased by the low pressure compressor 322, and is heated as a by-product of the pressurization by the low pressure compressor 322. In the example shown, the low pressure air is then provided to an intercooler 324 to reduce the temperature of the air before the air enters the high pressure compressor 326, where the air is further pressurized. In the example implementation shown, the high pressure air exiting the high pressure compressor 326 is provided to a heat recuperation unit 330 through a high pressure conduit 328. The heat recuperation unit 330 can be a heat exchanger configured to transfer heat energy from exhaust air (which is described below) to the high pressure air, i.e., to increase the temperature of the working fluid.

The high pressure air is also provided heat from a first heat source 332. The first heat source 332 is solar heat provided by solar energy that is incident on at least a portion of the surface area of the cavity. In this example, solar heat that is incident on the upper portion A₁ of the surface area of the cavity is the first heat source 332 and heats the working fluid before it enters the high pressure turbine 334. In some implementations, the working fluid is directed through a first flow path 333 that receives the solar heat incident on the upper portion A₁ of the surface area of the cavity. That is, the first flow path 333 can include tubing that is positioned behind the surface area of the upper portion A₁ and the solar heat is transferred through the surface area and into the working fluid within the tubing. The cross-sectional side view in FIG. 3A shows an implementation where the tubing, i.e., tubes 309, are positioned behind the surface area of the cavity. In another example, the first flow path 333 can include tubing that actually forms the surface area of the upper portion A₁, and the solar heat is conducted directly through the tubing into the working fluid (that is, the external surface of the tubing forms part of the wall of the cavity). In yet another example, the tubing that is positioned behind or in front of the surface area of the upper portion A₁, or that actually forms the surface area of the upper portion A₁, carries a second working fluid, e.g., water or molten salt. The second working fluid travels through the first flow path and is heated by the solar heat incident on the upper portion A₁. The second working fluid then passes through a heat exchanger (e.g., a liquid/air heat exchanger), which can form the first heat source 332, to conduct heat to the working fluid, i.e., the air, in the engine 304.

Whether the working fluid for the engine 304, i.e., the high pressure air, or a second working fluid is directed through the first flow path to receive solar heat from solar rays incident on the upper portion A₁ of the surface area of the cavity, the working fluid for the engine 304 is ultimately heated by the solar heat. That is, the working fluid is either heated directly by the solar heat or indirectly by a heat exchanger, where the second working fluid passing through the heat exchanger was heated by the solar heat. The heated high pressure air then enters the high pressure turbine 334 where it is allowed to expand. The expansion of the air through the high pressure turbine 334 urges the high pressure turbine 334 to rotate. The rotation of the high pressure turbine 334 urges rotation of the shaft 346, which in turn rotates the high pressure compressor 326 thereby causing the pressurization of the air entering the high pressure compressor stage. The rotation of the shaft 346 also drives the first generator 348 to generate electricity.

In some implementations, the first generator 348 may be omitted. For example, the high pressure turbine 334 can drive the high pressure compressor 326 alone. In some implementations, the high pressure compressor 326 can be omitted. For example, the high pressure turbine 344 can drive the first generator 348 alone. In some implementations, the system described can be employed in a hybrid system that uses solar energy together with another energy source, e.g., a fuel such as natural gas, to generate electricity.

Through expansion in the high pressure turbine 334, some of the thermal energy of the air is converted to mechanical work by the turbine. The expanded air is then provided to a second heat source 338 through a conduit 336. The second heat source 338 reheats the air flowing through the conduit 336. Similar to the first heat source 332, the second heat source 338 receives solar heat. In some implementations, the expanded air is directed through a second flow path 339 that receives the solar heat incident on the lower portion A₂ of the surface area of the cavity. That is, the second flow path 339 can include tubing (e.g., tubes 309) that is positioned behind the surface area of the lower portion A₂ and the solar heat is transferred through the surface area and into the working fluid within the tubing. In another example, the second flow path 339 can include tubing that actually forms the surface area of the lower portion A₂, and the solar heat is transferred directly through the tubing into the working fluid. In yet another example, the tubing that is positioned behind the surface area of the lower portion A₂ (or that actually forms the surface area of the lower portion A₂) carries a third working fluid, e.g., water. The third working fluid travels through the second flow path 339 and is heated by the solar heat incident on the lower portion A₂. The third working fluid then passes through a heat exchanger (e.g., a liquid/air heat exchanger), which can form the second heat source 338, to transfer heat to the working fluid, i.e., the air, in the engine 304. Either way, the working fluid in the engine 304 is reheated by solar heat (that is, directly or indirectly).

The reheated air is provided to the low pressure turbine 340 where the air is allowed to expand. The expansion of the air through the low pressure turbine 340 urges the low pressure turbine 340 to rotate. The rotation of the low pressure turbine 340 urges rotation of the shaft 342, which in turn rotates the low pressure compressor 322. The rotation of the low pressure compressor 322 causes the pressurization of the air entering the low pressure compressor 322 at 320. The rotation of the shaft 342 also drives the second generator 344 to generate electric power. In some implementations, the second generator 344 may be omitted. For example, the low pressure turbine 340 can drive the low pressure compressor 322 alone. In some implementations, the low pressure compressor 322 can be omitted. For example, the low pressure turbine 340 can drive the second generator 344 alone.

The air expanded through the low pressure turbine 340 is then provided to the heat recuperation unit 330 through a conduit 351. At the heat recuperation unit 330, heat energy from the air exiting the low pressure turbine 340 can be at least partially recovered and provided back to preheat the air prior to entering the first heat source 332. Once the exiting air passes through the heat recuperation unit 330, the exiting air can be exhausted, i.e., at 354.

In the example described above, a working fluid traveling through the first flow path 333 received solar heat from solar rays incident on the upper portion A₁ of the surface area of the cavity. A first subset of the heliostats 114 included in the field of heliostats can be directed to reflect solar rays incident on their reflective surfaces onto the upper portion A₁ of the surface area of the cavity. For example, the heliostat 114a can be included in the first subset, as this heliostat 114a is oriented to direct solar rays to the upper region 314 of the aperture of the receiver as was discussed above. The heliostat 114c can also be included in the first subset, as this heliostat is positioned further away from the receiver and is oriented to direct solar rays toward the center 130 of the aperture. Accordingly, the image of sunlight projected by the heliostat 114c will be positioned about the center 130 and will therefore be incident on both the upper portion A₁ and the lower portion A₂.

Similarly, in the example described above, a working fluid traveling through the second flow path 339 received solar heat from solar rays incident on the lower portion A₂ of the surface area of the cavity. A second subset of the heliostats 114 included in the field of heliostats can be directed to reflect solar rays incident on their reflective surfaces onto the lower portion A₂ of the surface area of the cavity. For example, the heliostat 114b can be included in the second subset, as this heliostat 114b is oriented to direct solar rays to the lower region 316 of the aperture of the receiver as was discussed above. The heliostat 114c can also be included in the second subset, as this heliostat is positioned further away from the receiver and is oriented to direct solar rays to the center 130 of the aperture. Accordingly, the image of sunlight projected by the heliostat 114c will be positioned about the center 130 and will therefore be incident on both the upper portion A₁ and the lower portion A₂. As such, the first and second subsets of heliostats may or may not be mutually exclusive. In the above example, they are not mutually exclusive, as the heliostat 114c is included in both the first and second subsets.

The heliostats that are included in the first and the second subsets can selectively be changed to adjust the level of solar heat provided to the first flow path and the second flow path. In this example, the level of solar heat provided by the first heat source 332 to the first stage of the engine 304 (i.e., the high pressure stage) can thereby be adjusted and controlled. Similarly, the level of solar heat provided by the second heat source 338 to the second stage of the engine 304 (i.e., the lower pressure stage) can also be adjusted and controlled. For example, if more heat is desired for the first stage, at least some of the heliostats that are included in the second subset, i.e., that are directed to reflect solar rays to the lower portion A₂, can be added to the first subset, i.e., directed to reflect solar rays to the upper portion A₁. The upper portion A₁ will then be subject to more intense solar energy and can provide increased solar heat to the working fluid in the first flow path 333. The reverse can occur to increase the solar heat provided to the second heat source 338.

In some implementations, temperature of the working fluid at one or more locations in the engine 304 can be determined. Based on the determined one or more temperatures, the heliostats included in one or both of the first and second subsets can be changed. For example, if the temperature of the working fluid is measured just after the working fluid is heated by the first heat source 332 and is below a predetermined threshold temperature, then the solar heat provided to the first heat source 332 can be increased. That is, the first subset of heliostats can be changed to include more and/or different heliostats than before.

In some implementations, the solar intensity incident on the surface area of the receiver can be determined at one or more locations, and based on the solar intensity the heliostats included in one or both of the first and second subsets can be changed. For example, if the solar intensity at a location on the surface area of the receiver exceeds a predetermined threshold value, then it may be desired to reduce the solar intensity at this location to minimize the risk of damaging the receiver by over-heating. Accordingly, the heliostats included in the subset of heliostats that are directed to reflect solar rays to this location of the surface area can be changed to reduce the solar intensity incident at that location.

In some implementations, the heliostats that are included in the first and second subsets can be selected based, at least in part, on the power being produced by the engine at a given time. That is, in the each morning and late afternoon when the engine is operating at lower power, it may be more efficient to reduce the amount of heat provided at the re-heat location, i.e., the second stage, due to restrictions on the recuperator inlet temperature, and to increase the amount of heat provided at the first stage. That is, in a two-stage intercooled recuperated reheat cycle engine, such as the engine 304, solar heat is added just before each of the two turbine stages, i.e., at 332 and 338. At reduced-power operating times, the pressure ratio of the low pressure stage may naturally decrease, resulting in less power extraction from the low pressure turbine 340. The reduced power extraction also means that the temperature change across the low pressure turbine 340 is reduced. The low pressure turbine temperature drop together with the recuperator inlet temperature limit can thereby set the upper limit on the low pressure turbine inlet temperature. However, by selectively controlling the amount of heat provided at the first and second heat sources (i.e., by selectively changing which heliostats are included in the first and second subsets), the overall engine efficiency can be improved.

In the example heliostat field shown, heliostats in different subsets are different distances from the receiver. However, it should be understood that in some implementations, heliostats in different subsets can be, on average, the same distance from the receiver, for example, if positioned on opposite sides of the receiver tower.

When a solar plant, e.g., the power generation module 108, has been configured with a “solar multiple” of greater than 1, there may be more solar power available at times of the day than can be absorbed by the receiver 102. The solar multiple is the ratio of the actual heliostat area to the heliostat area that would be required to enable the power generation module 108 to produce rated power at the one time in the year that the maximum possible solar energy can be delivered by the heliostat field 114 onto the receiver 102. Solar multiples are usually chosen a value greater than one in order to optimize the overall operation of the power generation module by increasing the amount of time that the power generation module runs at rated power. By way of illustrative and non-limiting example, solar multipliers may be in the range of 1.2 to 1.5.

In some implementations, when there is excess solar power available, not all the heliostats are deployed to reflect sunlight onto the receiver 102, e.g., during the times of the day when excess solar power is available. The efficiency of the system can be optimized by selecting which heliostats to deploy and what locations within the aperture to direct them to reflect solar rays. For example, there may be portions of the surface area of the cavity 106 with higher flux distributions, i.e., potential hot spots. During times when not all the heliostats 114 are needed, those heliostats that are contributing the most to the hot spots can be de-focused, i.e., directed to reflect solar rays away from the receiver 102. In another example, the farthest away heliostats can be preferentially de-focused. The remaining active heliostats can have flexibility to aim at different regions of the aperture 104 without spilling light at the aperture 104, i.e., on account of the smaller dimensioned images of sunlight projected by the closer-in heliostats on the receiver. In some implementations, some of the heliostats are aimed toward an edge of the aperture, purposely spilling some light, in order to achieve a desired flux distribution in the cavity. Such aiming may occur during times when there is excess solar power available.

In some implementations, the methods described herein for controlling the solar heat incident on certain portions of the surface area of the cavity can be applied whether or not the portions of the surface area correspond to different flow paths of a working fluid. That is, in some implementations, the methods can be used to provide a custom aiming strategy for the heliostats control the solar heat incident on the surface area of the cavity, e.g., to prevent damage to the cavity from overheating as mentioned above. The aiming strategy can be customized to keep the local temperature at the surface of the cavity from exceeding predetermined threshold limits. The aiming strategy also can be customized to shape the solar flux distribution on the cavity surface such that high flux is directed at portions of the surface area that have lower-temperature working fluid flowing through the receiver tubing at that location, and can therefore support the higher heat flux with higher delta-temperature, while not exceeding material temperature limits.

In some implementations, the expected intensity of the Sun can be predicted based on the time of day and/or the day of the year. The heliostats included in the first and second subsets can be selectively changed based on the given time on a given day of the year based on the expected Sun intensity at the given time on the given day. The actual Sun intensity may be different than expected, i.e., due to weather conditions. Accordingly, in some implementations, the actual Sun intensity is measured and used to selectively change the heliostats included in the first and second subsets. For example, during low solar intensity times of the day (e.g., early morning or late afternoon), more heliostats may be included in the first subset then during high solar intensity times of the day (e.g., mid-day), because the solar rays from fewer heliostats may generate approximately the same amount of solar heat during the high solar intensity time of day. Other factors, or a combination of one or more of the above discussed factors, can be used to selectively change the heliostats that are included in one or more both of the subsets. The factors discussed are illustrative and non-limiting.

Referring again to FIG. 1 and FIG. 3B, a control system 150 can be coupled to the receiver 102 and to the heliostats 114. The control system 150 can be configured to selectively change the heliostats that are included in the first and second subsets to adjust the level of heat provided to the upper portion A₁ and lower portion A2 of the surface area respectively. In some implementations, the control system 150 can be configured to receive temperature information from one or more sensors that measure temperature at one or more locations within the engine 304 and/or on the surface area of the cavity. Changes to which heliostats are included in the subsets can be based, at least in part, on this temperature information. The control system 150 can be configured to change which heliostats are included in the subsets based, at least in part, on the expected or actual intensity of the Sun at different times throughout the day. The control system 150 can be configured to receive solar intensity information from one or more sensors that measure solar intensity at one or more locations within the receiver, e.g., at the one or more locations on the surface of the cavity or at or about the aperture 104. The control system 150 can change which heliostats are included in the subsets based, at least in part, on the received solar intensity information.

In some implementations, the control system 150 is implemented remote from the receiver 102 and the heliostats 114 but is in communication with the receiver 102 and heliostats 114, e.g., by communication lines, which may in some implementations also conduct power to the heliostats 114 (e.g., to energize their pitch and angle mechanisms). In some implementations, the communication lines may be supplemented or replaced by wireless communication links between the receiver 102 and heliostats 114 and the control system 150. The control system 150 can thereby receive information that is captured at the receiver 102, e.g., temperature information and solar intensity information as was discussed above. The control system 150 can also thereby communicate with the individual heliostats 114 to direct them to reflect solar rays incident on their reflective surfaces to a selected location within the aperture (i.e., depending on in which subset or subsets each heliostat is included).

As ways discussed above, the heliostats 114 are each able to vary the direction in which their one or more reflective surfaces are pointing. As such, the heliostats 114 can be pitched and angled so as to selectively reflect incoming sunlight to a region of the aperture 104. The heliostats' 114 pitches and angles can be varied throughout the day to track the Sun as it appears to move across the daytime sky in order to maintain their reflective relationship with the receiver and more particularly, with the region of the aperture 104 to which they are assigned to direct solar rays.

The control system 150 can further include a heliostat tracking sub-system that is configured to control the positioning of the reflective surfaces included on each of the heliostats 114 based on a position of the Sun and on the locations within the aperture to which the heliostats are directed to reflect solar rays toward. In some implementations, the heliostat tracking sub-system is implemented as an individual controller located at each of the individual heliostats or assigned to a group of heliostats (e.g., controller 160). The multiple individual controllers 160 can be in communication with the remote control system 150, e.g., through a wired or wireless connection as discussed above.

Each local controller 160 can substantially control the pitch and angle of the corresponding heliostat to control the direction in which the heliostat's light is reflected, e.g., based on the position of the Sun (either known or estimated) and based on an assignment sent from the control system 150 as to which location in the aperture 104 to direct solar rays. In other implementations, the determination of the desired pitch and angle of the heliostat's reflective surface can be made remotely, e.g., at the control system 150, and the control system 150 can provide signals to the local controller 160 at the heliostat so as to direct the controller to adjust the pitch and angle of the reflective surface accordingly.

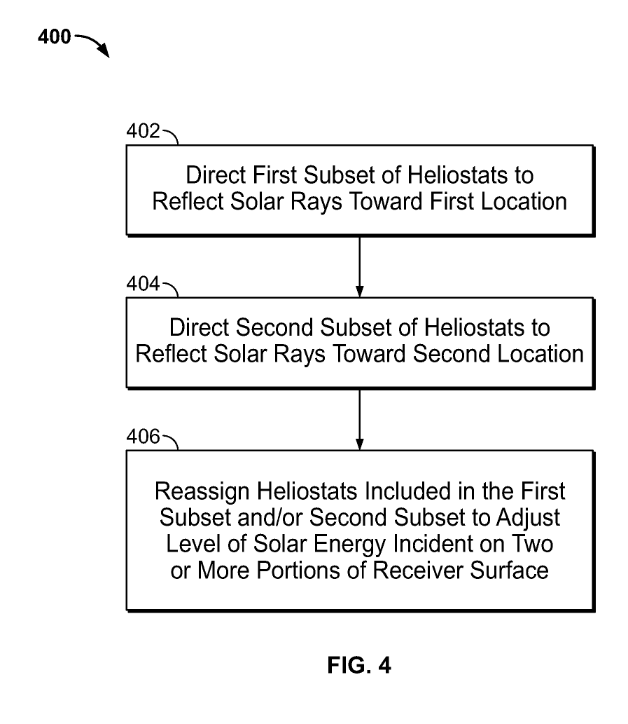

FIG. 4 is a flowchart showing an example process 400 for assigning heliostats to direct solar rays to particular locations. The heliostats are included in a heliostat field that is positioned to direct solar rays toward to a receiver. For purposes of illustration, the heliostats can be included in the field of heliostats 114 which are positioned to direct solar rays toward the receiver 102. A first subset of heliostats is directed to reflect solar rays toward (i.e., aim toward) a particular first location within the receiver aperture (Box 402). That is, again by way of illustrative example, the first subset of heliostats may include heliostats that are positioned relatively close to the receiver 102, e.g., heliostat 114a. Because the image of sunlight projected by this heliostat on the aperture 104 is smaller in dimension than the aperture 104, there is some flexibility in where the heliostat 114a aims the solar rays it reflects while still avoiding spillover. The heliostat 114a in this example is directed to aim toward the upper region 314 of the aperture 104, and in a particular example, can be directed to aim the center of the image projected by the heliostat at approximately the location 311.

A second subset of heliostats is directed to reflect solar rays toward a second location within the receiver aperture (Box 404). For example, the second subset of heliostats may include the heliostat 114b that is directed to aim solar rays toward a second location included in the lower region 316 of the aperture.

In this example, some of the heliostats, for example, heliostat 114c, are directed to aim solar rays toward the center 130 of the aperture 104, so as to avoid or minimize spillover, on account of the larger dimension image projections of these heliostats on the aperture 104. Accordingly, these heliostats may be effectively in both the first and the second subsets, in that the solar rays reflected from them are incident on both the upper portion A₁ and the lower portion A₂ of the surface area of the cavity 106. As was discussed above, at certain times of the day, it may be advantageous to de-focus some or all of these heliostats entirely, to reduce the solar heat incident on the surface area of the cavity 106.

The heliostats that are included in the first subset and/or the second subset can selectively be changed to adjust the level of solar heat incident on certain portions of the surface area of the cavity 106 (Box 406). Various factors, either alone or in combination, can be used to determine whether to change the heliostats included in a subset. Changing the heliostats can include adding heliostats, removing heliostats or both, which can increase, decrease or not change the overall number of heliostats included in the subset. Heliostats that are removed can be assigned to another subset to direct solar rays at a different portion of the surface area, or can be de-focused (i.e., directed to reflect solar rays away from the receiver) or partially de-focused (i.e., to intentionally spill some of the light, e.g., at times when there is excess solar energy available). Examples of factors that can be used to determine whether and how to change the heliostats included in one or more of the subsets have been described above and can be used here.

In the examples described above and in reference to FIGS. 2-4, the heliostats were assigned to one or none of two subsets that were directed to reflect solar rays toward either the upper portion A₁ or lower portion A₂ of the surface area of the cavity 106 or away from the receiver altogether (i.e., de-focused). However, it should be understood that in other implementations, there can be more than two target portions of the surface area, and therefore more than two corresponding subsets of heliostats. The target portions of the surface area do not have to be symmetrical, as they are in the example shown, and they do not have to be the same size as each other, nor does a particular portion have to be a contiguous portion. There can be more subsets of heliostats than corresponding portions of the surface area. For example, one subset may be directed to reflect solar rays away from the receiver, or two or more subsets may be directed to reflect solar rays toward the same portion of the surface area. Various configurations are possible, and the example described herein is but one example for illustrative purposes.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A method for aiming heliostats toward a receiver, comprising:
directing a first subset of a set of heliostats to reflect solar rays toward a first location within an aperture of a receiver, wherein the solar rays reflected toward the first location provide solar heat to at least a first flow path of a working fluid in an engine assembly coupled to the receiver; and
directing a second subset of the set of heliostats to reflect solar rays toward one or more second locations within the aperture of the receiver, wherein the solar rays reflected toward the one or more second locations provide solar heat to a second flow path of the working fluid;
wherein the first flow path and the second flow path correspond to heating at a first stage and a second stage respectively within the engine assembly that is coupled to the receiver and is configured to generate power from the solar rays reflected to the receiver.

2. The method of claim 1, further comprising:
selectively changing which heliostats are included in at least one of the first subset the second subset to adjust a level of heat provided to at least one of the first flow path or the second flow path.

3. The method of claim 2, further comprising:
measuring temperature of the working fluid at one or more locations in the engine assembly;
wherein selectively changing the heliostats is based at least in part on the measured temperatures.

4. The method of claim 2, further comprising:
determining solar intensity incident on the receiver;
wherein selectively changing the heliostats is based at least in part on the determined solar intensity.

5. The method of claim 2, wherein at a given time on a given day selectively changing the heliostats is based at least in part on expected intensity of the Sun at the given time on the given day.

6. The method of claim 1, wherein:
the first location is substantially coincident with a center of the aperture; and
the one or more second locations are located one or more predetermined distances away from the center.

7. The method of claim 6, wherein:
the first subset of heliostats is located further away from the receiver than the second subset of heliostats.

8. The method of claim 1, wherein the engine assembly includes at least a first turbine and a second turbine and the working fluid comprises air, the method further comprising:
directing air in the engine through the first flow path for heating prior to entering the first turbine;
directing air exiting the first turbine through the second flow path for re-heating prior to entering the second turbine;
wherein at least one of the first turbine or the second turbine provides mechanical energy to a generator that is configured to produce electricity.

9. The method of claim 8, wherein the engine comprises a multi-stage compression Brayton-cycle engine.

10. The method of claim 1, wherein the solar rays reflected toward the first location also provide solar heat to the working fluid in the second flow path.

11. A system comprising:
a receiver tower positioned in proximity to a plurality of heliostats and including a receiver mounted on the receiver tower configured to receive solar rays directed to the receiver from the plurality of heliostats;
a first subset of heliostats of the plurality of heliostats, wherein the first subset is directed to reflect solar rays to a first location within an aperture of the receiver;
a second subset of heliostats of the plurality of heliostats, wherein the second subset is directed to reflect solar rays to one or more second locations within an aperture of the receiver; and
an engine coupled to the receiver, wherein a working fluid in the engine is directed through a first flow path that receives solar heat from the solar rays directed to the first location and the working fluid is directed through a second flow path that receives solar heat from at least the solar rays directed to the one or more second locations.

12. The system of claim 11, wherein:
the engine includes at least a first turbine and a second turbine and the working fluid comprises air that is directed through the first flow path for heating prior to entering the first turbine and is directed through the second flow path for re-heating after exiting the first turbine and prior to entering the second turbine.

13. The system of claim 12, further comprising:
at least one generator coupled to at least one of the first turbine or the second turbine, the generator configured to receive mechanical energy from the at least one turbine and to generate electricity.

14. The system of claim 11, wherein the receiver includes a cavity formed behind the aperture such that solar rays directed to the first location within the aperture are incident on a first portion of a surface area of the cavity and solar rays directed to the one or more second locations within the aperture are incident on a second portion of the surface area of the cavity.

15. The system of claim 14, wherein the first flow path receives solar heat from the solar rays incident on the first portion of the surface area and the second flow path receives solar heat from the solar rays incident on the second portion of the surface area.

16. The system of claim 11, further comprising:
a controller configured to selectively change which heliostats are included in at least one of the first subset or the second subset to adjust a level of heat provided to the working fluid directed through at least one of the first flow path or the second flow path.

17. The system of claim 16, wherein the controller is further configured to:
receive temperature information from one or more sensors measuring temperature of the working fluid within the engine; and
selectively change the heliostats based on the temperature information.

18. The system of claim 16, wherein for a given day the controller is further configured to selectively change the heliostats based on expected intensity and location of the Sun at different times throughout the given day.

19. The system of claim 16, wherein for a given day the controller is further configured to:
receiver solar intensity information from one or more sensors measuring solar intensity at one or more locations within the receiver; and
selectively change the heliostats based on the solar intensity information.

20. A system comprising:
a receiver tower positioned in proximity to a plurality of heliostats and including a receiver mounted on the receiver tower configured to receive solar rays directed to the receiver from the plurality of heliostats, wherein the receiver includes a cavity having a surface area that is formed behind the aperture;
a first subset of heliostats of the plurality of heliostats, wherein the first subset is directed to reflect solar rays to a first location within an aperture of the receiver, which solar rays are incident on a first portion of the surface area of the cavity;
a second subset of heliostats of the plurality of heliostats, wherein the second subset is directed to reflect solar rays to a second location within the aperture of the receiver, which solar rays are incident on a second portion of the surface area of the cavity; and
an engine coupled to the receiver, wherein a working fluid of the engine is heated at a first stage by solar heat from the first portion of the surface area of the cavity and is re-heated at a second stage by solar heat from the second portion of the surface area of the cavity.

21. The system of claim 20, wherein the working fluid passes through a first flow path that receives the solar heat from the first portion of the surface area of the cavity and passes through a second flow path that receives the solar heat from the second portion of the surface area of the cavity.

22. The system of claim 21, wherein the first flow path comprises a path through a first tubing that is positioned behind or in front of the first portion of the surface area of the cavity and the second flow path comprises a path through a second tubing that is positioned behind or in front of the second portion of the surface area of the cavity.

23. The system of claim 21, wherein the first flow path comprises a path through a first tubing that has an external surface that comprises the first portion of the surface area of the cavity and wherein the second flow path comprises a path through a second tubing that has an external surface that comprises the second portion of the surface area of the cavity.

24. The system of claim 20, the engine further comprising:
a first heat exchanger configured to transfer heat from a first working fluid to the working fluid of the engine to provide heat at the first stage; and
a second heat exchanger configured to transfer heat from a second working fluid to the working fluid of the engine to provide heat at the second stage;
wherein the first working fluid is directed through a first flow path that receives solar heat from the first portion of the surface area and the second working fluid is directed through a second flow path that receives solar heat from the second portion of the surface area.

25. The system of claim 20, further comprising:
a controller configured to selectively change which heliostats are included in at least one of the first subset or the second subset to adjust a level of heat provided to the working fluid at the first stage or the second stage.
